(19) United States
(12) Patent Application Publication
(10) Pub. No.: US 2018/0298957 A1
(43) Pub. Date: Oct. 18, 2018

(54) Shifting Element for an Automatic Transmission

(71) Applicant: ZF Friedrichshafen AG, Friedrichshafen (DE)

(72) Inventors: Rudolf Kauffeldt, Bodolz (DE); Matthias Uhl, Friedrichshafen (DE); Michel Morsch Caspari, Friedrichshafen (DE)

(21) Appl. No.: 15/949,228

(22) Filed: Apr. 10, 2018

(30) Foreign Application Priority Data
Apr. 10, 2017 (DE) 10 2017 206 053.0

(51) Int. Cl. F16D 13/68; F16H 63/30; F16D 13/52

(52) U.S. Cl. CPC F16D 13/683; F16H 2063/3093; F16D 13/52; F16H 63/30

(57) ABSTRACT

A shift element (1) for an automatic transmission of a motor vehicle includes a first (2) and a second shift-element half (3). Each shift-element half includes a disk carrier (4, 5) and multiple essentially annular disks (11-14, 51-54). Multiple disks (11, 12) of the disk carrier (4) of at least one shift-element half (2) are designed in such a way that the disks have a defined imbalance. The disks (11, 12) having the defined imbalance are arranged or rotated relative to each other, with consideration for the size of the particular imbalance, in such a way that, in sum, the imbalances of the disks (11, 12) at least approximately cancel each other out and therefore, overall, this shift-element half (2) has no imbalance or at least a clearly reduced imbalance.

### FIELD OF THE INVENTION

The invention relates generally to a friction-locking shift element for an automatic transmission, in particular a multi-disk clutch.

### BACKGROUND

It is known that shift elements, which are also referred to as clutches or brakes, are utilized in automatic transmissions in particular, in order to fix the appropriate elements of a planetary gear train depending on the desired transmission ratio step, i.e., to connect the elements to the transmission housing in a rotationally fixed manner (brake) or to connect multiple components of the planetary gear train to each other in a rotationally fixed manner (clutch). The designation “clutch” is utilized in general for a shift element of a transmission. Elements of a planetary gear train are the ring gear, the sun gear, and the carrier, as well as the planet gears rotatably mounted on the carrier.

A shift element includes two shift-element halves. In order to implement different transmission ratio steps of an automatic transmission, it is necessary to disengage a certain number of friction-locking shift elements and engage a certain number of other shift elements. In this case, “disengage” means that the torque transmission capacity of the particular shift element is reduced up to the ideally complete decoupling of the shift-element halves. In this context, “engage” means that, starting from a decoupled state, the shift-element halves are connected to each other in a rotationally fixed manner.

Advantageously, friction-locking shift elements are utilized in automatic transmissions for motor vehicles, since a change in the transmission ratio step, which is also referred to as a gear change operation, without an interruption of tractive force is possible with the aid of such elements, which results in a high level shifting comfort and good acceleration behavior of the motor vehicle.

A particularly widespread design of a friction-locking shift element for an automatic transmission is the lamellar shift element, which is also referred to as a multi-disk clutch, preferably rotating in oil. Such an automatic transmission is described in DE 19932614 A1 which belongs to the applicant. A first clutch half or shift-element half includes, in this case, an essentially hollow-cylindrical outer disk carrier including multiple circular annular disk-shaped outer clutch disks which are arranged therein and include external gearing, by which the outer clutch disks are coupled in a rotationally fixed manner to the outer disk carrier including internal gearing. The inside contour or the inside edge of the outer clutch disks is usually circular. The outer clutch disks are axially displaceable with respect to the outer disk carrier. A second shift-element half includes an essentially hollow-cylindrical inner disk carrier including circular annular disk-shaped inner clutch disks which are arranged around the inner disk carrier and include internal gearing, by which the inner clutch disks are coupled, in a rotationally fixed manner, to the inner disk carrier including external gearing. The external contour or the outside edge of the inner clutch disks is usually circular. The inner clutch disks are axially displaceable with respect to the inner disk carrier.

The inner disk carrier has a smaller diameter than the outer disk carrier and is arranged radially within the outer disk carrier, and therefore the outer and inner clutch disks are arranged radially between the outer disk carrier and the inner disk carrier. The outer disk carrier and the inner disk carrier are arranged concentrically to one another about a shared axis. They are essentially hollow cylindrical, although they can also have a certain taper due to manufacturing.

During operation, the inner clutch disks rotate with the inner disk carrier and the outer clutch disks rotate with the outer disk carrier, provided the shift element is not designed as a brake and one of the two disk carriers is connected to a transmission housing in a rotationally fixed manner. In the following, an “axial direction” is understood to be in the direction of the coincident axes of rotation of the two disk carriers. The inner clutch disks can have a circular contour radially outward and the outer clutch disks can have a circular contour radially inward, in both cases corresponding to their circular annular disk shape.

In the assembled state of the multi-disk clutch, the outer clutch disks and the inner clutch disks alternate in the axial direction. In order to engage the multi-disk clutch for torque transmission, the disks are pressed against one another in the axial direction until the friction force between the disks is so great that a torque can be transmitted. The full torque can be transmitted when the contact pressure is so great that the outer disk carrier and the inner disk carrier are connected to each other in a friction-locking, rotationally fixed manner.

In the disengaged state of the multi-disk clutch, no axial force is applied onto the outer disk carrier and the inner disk carrier, and they may loosely touch one another. In the case of a disengaged multi-disk clutch, there is usually a speed differential between the outer disk carrier and the inner disk carrier, which can be quite high, depending on the other selected gear ratios in the automatic transmission. For example, the speed of one disk carrier can be a multiple of the speed of the other disk carrier or of the engine speed which is the input speed of the automatic transmission (for example, factor 2.16 in one specific application).

In the state in which the disks are mounted on their respective disk carriers, there is radial play, due to manufacturing, between the disks and the disk carrier, on or in which the disks are arranged. In addition, the disks can have an imbalance due to manufacturing tolerance. An imbalance occurs at a rotary component when the center of gravity of the rotary component is radially spaced from the axis of rotation.

If a disk carrier then rotates in the disengaged state of the clutch, each disk shifts within the scope of its radial play and/or under the effects of its deadload and the manufacturing tolerance-related imbalance, and therefore the center of gravity of the disk, which usually corresponds to the center of the circular inner and outer contours of the disk, is spaced from the axis of rotation of the disk carrier. The direction of the displacement cannot be influenced. This results in a centrifugal force, as a revolving radial force, which is computed as the product of the distance from the center of gravity to the axis of rotation multiplied by the mass of the disk and the square of the angular frequency. The product of mass and distance is referred to as imbalance. In the least favorable case, all disks shift in the same direction, and therefore the individual imbalances add up and, in this way, a maximum imbalance results. In addition to the imbalance which results from the displacement within the radial play, a manufacturing tolerance-related imbalance of the individual disks can also be added.

If the outer disk carrier and/or the inner disk carrier then rotate/rotates in the disengaged state of the clutch, in particular at high speeds, with an imbalance which is generated by the displaced disks, this causes the disk carrier to wobble, i.e., the axis of rotation of the disk carrier wobbles about the original, geometric axis of rotation of the disk carrier, or about the axis of rotation, about which the disk carrier would rotate if balanced. The undesirable effects are vibrations, noises, and material destruction, as well as damage to shafts and bearings due to the alternating bending loads. In addition, pitting in the splines can occur. Moreover, due to the wobbling movement of the disk carrier, friction can occur between the disks, whereby the drag torque of the disengaged shift element increases.

### SUMMARY OF THE INVENTION

Example aspects of the invention provide a shift element, in which the occurrence of an imbalance of a disk carrier during operation is avoided or at least clearly reduced in an easy way.

According thereto, a shift element for an automatic transmission of a motor vehicle includes a first and a second shift-element half, wherein each shift-element half includes a disk carrier and multiple essentially circular annular disk-shaped disks. In this case, each disk carrier and the disks assigned thereto are coupled to one another in a form-locking and rotationally fixed manner and the disks are axially movable with respect to the particular disk carrier coupled thereto. The disk carriers and, therefore, the shift-element halves can be coupled to one another, by the disks, in a rotationally fixed manner or so as to slip in a relative movement with respect to one another.

According to the invention, multiple disks of the disk carrier of at least one shift-element half are designed in such a way that the disks have a defined imbalance. In the assembled state of the at least one shift-element half, these disks, which have a defined imbalance, are arranged or are rotated relative to each other on their disk carrier, with consideration for the location and size of a particular defined unbalanced mass, in such a way that, during operation, the disks shift radially, deliberately in the direction of their particular unbalanced mass or the center of gravity resulting therefrom, and therefore, in sum, imbalances occurring during operation due to the displacement of the disks cancel each other out or are at least partially compensated.

As a result, the at least one shift-element half—depending on the portion of the disks which are designed and arranged in this way—has, overall, no imbalance or only a slight imbalance and is at least essentially balanced, thereby avoiding the disadvantages described at the outset. In particular, the invention results in a low-noise and low-vibration operation of the shift-element half. The positive effect is most pronounced when all disks of a disk carrier have a defined imbalance and are appropriately arranged.

Yet another positive effect is an avoidance of the so-called disk wobble, in the case of which the disk not only shifts in an unknown radial direction, but also shifts while revolving about the disk carrier. One possible effect thereof would be an elevated drag torque of the clutch and, therefore, reduced transmission efficiency.

Preferably, the size of the defined imbalance is to be selected in such a way that the imbalance is greater than a manufacturing tolerance-related imbalance of a disk plus an imbalance resulting from the radial displacement of a center of gravity of the disk from its axis of rotation.

Such a radial displacement can take place due not only to the radial play of a disk with respect to the disk carrier, but additionally due to a deviation of coaxiality of the disk carrier with respect to the drive axle. Only in this way it is ensured that the disk shifts in a defined direction.

In one embodiment it is possible that, when there is an even number of disks on a disk carrier that have a defined imbalance, each group of two disks has the same defined imbalance and is arranged on the disk carrier in such a way that the unbalanced masses and, therefore, the centers of gravity of the two disks, are rotated 180° relative to each other about an axis of rotation of the disk carrier or the shift-element half.

As an alternative or in addition thereto, it is possible that, when there is an uneven number of disks on a disk carrier that have a defined imbalance, each of these disks has the same defined imbalance, and wherein their unbalanced masses or centers of gravity are rotated relative to each other through a certain identical angle about a central axis of the disk carrier. The certain angle is computed, in this case, as the quotient of 360° divided by the number of disks having an imbalance.

In the case of a disk carrier having an uneven number of disks, it is provided in one alternative embodiment that the disks having a defined imbalance form at least two groups, wherein the disks within one group each have the same defined imbalance. One first group in this case includes an even number of disks and one second group includes an uneven number of disks. Therefore, the situation can be avoided in which, when there is an uneven number of more than three disks that should be displaced relative to each other by a certain identical angle, a division arises that is too small or is difficult to implement. The disks can be arranged so as to be rotated, in pairs, 180° with respect to each other and the largest uneven number of disks having the same defined imbalance that occurs in one group is three.

In one preferred embodiment of a shift element, each disk carrier and each disk includes a driving profile, by which the disks are coupled to the particular disk carrier in a form-locking and rotationally fixed manner, wherein at least two disks include at least one off-center recess which is designed in such a way that the center of gravity of the disk is radially spaced from an axis of rotation of the disk, and so the disk has a defined unbalanced mass. In the following, a “recess” is understood to mean that a portion of a disk according to the prior art is lacking or has been recessed.

Alternatively thereto, it can be provided that each disk carrier and each disk includes a driving profile, by which the disks are coupled to the particular disk carrier in a form-locking and rotationally fixed manner, wherein at least two disks include at least one radially oriented bulge. In the following, a “bulge” is understood to mean that a disk includes more material at one or more points than does a disk according to the prior art, which usually does not have a defined imbalance. The bulge is designed in such a way that the center of gravity of the disk is radially spaced from an axis of rotation of the disk, whereby the disk has a defined unbalanced mass. In order to enable a disk designed in this way to be coupled to a disk carrier in a rotationally fixed manner, the driving profile of the disk carrier assigned to the disks includes a driving-profile gap which is designed in such a way that, in the assembled state of the shift-element half, the bulge of the disk can engage into the driving-profile gap. The advantage of such an embodiment is a high certainty of assembly, since it is no longer possible to incorrectly mount a disk having a defined imbalance by only a relatively small angle of, for example, one pitch module.

In one particular embodiment of the invention, the first shift-element half includes one outer disk carrier and multiple outer clutch disks and the second shift-element half includes an inner disk carrier and multiple inner clutch disks, wherein the outer disk carrier includes an internally geared outer-disk-carrier tooth system and the outer clutch disks each include external gearing, by which the outer clutch disks are coupled to the outer disk carrier in a rotationally fixed manner. The inner disk carrier includes an externally geared inner-disk-carrier tooth system and the inner clutch disks include internal gearing. By these tooth systems, the inner clutch disks are coupled to the inner disk carrier in a rotationally fixed manner. In this case, at least one recess in the form of a tooth-system gap is formed in the external gearing of at least two outer clutch disks and/or in the internal gearing of at least two inner clutch disks, in that at least one tooth is at least partially lacking from the tooth system, thereby resulting in the defined imbalance of the disks.

Alternatively, it would also be conceivable to generate the defined imbalance with the aid of a bore or a through hole in the disk that is radially spaced from the center of the disk.

It is preferably possible that the number of outer clutch disks having a defined imbalance is even and that a tooth-system gap is formed on each of these outer clutch disks via the lack of at least two adjacently situated teeth, and therefore each relevant outer clutch disk has an identical defined imbalance, wherein the unbalanced mass corresponds to the mass of the two lacking teeth.

Depending on the size of the desired defined imbalance, which must exceed the manufacturing tolerance-related imbalance of the disk in order to fulfill the function, the tooth-system gap can also be obtained by removing more than two teeth.

In one particularly advantageous embodiment of the invention, it is provided that the first shift-element half includes one outer disk carrier and multiple outer clutch disks and the second shift-element half includes an inner disk carrier and multiple inner clutch disks, wherein the outer disk carrier includes an internally geared outer-disk-carrier tooth system and the outer clutch disks each include external gearing, by which the outer clutch disks are coupled to the outer disk carrier in a rotationally fixed manner, and wherein the inner disk carrier includes an externally geared inner-disk-carrier tooth system and the inner clutch disks include internal gearing, by which the inner clutch disks are coupled to the inner disk carrier in a rotationally fixed manner.

In this case, formed in the external gearing of at least two outer clutch disks and/or in the internal gearing of at least two inner clutch disks is at least one at least partially non-toothed area which forms a positioning lug, and therefore the relevant outer clutch disk includes at least one radially outward-oriented positioning lug and/or the relevant inner clutch disk includes a radially inward-oriented positioning lug. This yields a defined imbalance of the relevant disks during operation.

On the particular disk carrier on which the disk designed in this way is arranged, a disk carrier tooth-system gap is formed by the at least partial lack of at least one disk carrier tooth, into which disk carrier tooth-system gap the positioning lug engages in the assembled state of the shift element. Due to this embodiment, the possibility of an assembly error is reduced, since a disk can be positioned on the disk carrier only in certain positions. It is essential for a compensation of the defined imbalances of the disks that the disks are arranged on the disk carrier so as to be rotated through a certain angle with respect to each other. In this embodiment, the positioning is possible only within the disk carrier tooth-system gaps, into which the positioning lug of the particular disk is inserted, i.e., there are only that many different mounting positions as there are disk carrier tooth-system gaps. The number thereof is clearly less than the number of teeth, within which the disks can be inserted in an embodiment without a positioning lug.

In this context, it is provided that the at least partially non-toothed positioning lug is formed by way of no tooth spaces having been blanked or milled out of the disk at the location of the positioning lug. The blanking tool can also be designed in this way.

In one preferred embodiment of the shift element, all disks of at least one disk carrier or of at least one shift-element half have a defined imbalance. It is thereby made possible to avoid imbalances during operation as completely as possible.

It is possible that the above-described shift element is designed as a brake, i.e., it includes only one rotary shift-element half; the other shift-element half is connected to the transmission housing in a rotationally fixed manner. In this case, only the rotary shift-element half includes disks having a defined imbalance. It would not be necessary to balance the stationary shift-element half.

The shift element according to the invention can also be designed as a clutch, wherein both rotary shift-element halves include disks having a defined imbalance. Alternatively thereto, it would also be possible to balance, according to the invention, only that shift-element half that reaches the higher speed and, therefore, is more critical in terms of the undesirable effects of an overall imbalance.

An automatic transmission for a motor vehicle includes at least one shift element according to the invention, which can be designed as described above. Due to the reduced or compensated imbalance of the shift element, the automatic transmission offers advantages in terms of low noise operation, wear, and operating life. In addition, the transmission efficiency increases due to the drag torque being reduced as compared to non-balanced shift-element halves.

### BRIEF DESCRIPTION OF THE DRAWINGS

Exemplary embodiments of a clutch according to the invention are represented in the drawings and are described in greater detail in the following.

In the drawings

FIG. 1 shows a longitudinal section through a multi-disk clutch according to a first example embodiment,

FIG. 2 shows a first cross-section through the example multi-disk clutch of FIG. 1 with the axial view of a first outer clutch disk,

FIG. 3 shows a second cross-section through the example multi-disk clutch of FIG. 1 with the axial view of a second outer clutch disk,

FIG. 4 shows a longitudinal section through a multi-disk clutch according to a second example embodiment,

FIG. 5 shows a first cross-section through the example multi-disk clutch of FIG. 4 with the axial view of a first outer clutch disk,

FIG. 6 shows a second cross-section through the example multi-disk clutch of FIG. 4 with the axial view of a second outer clutch disk, and

FIG. 7 shows a detailed section of a portion of the first outer clutch disk of FIG. 5.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

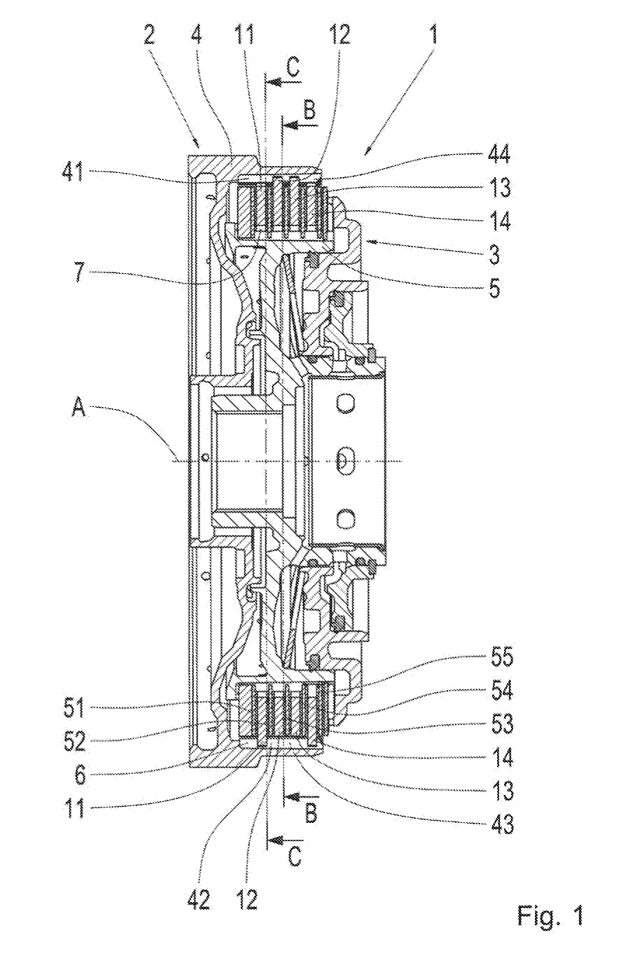

FIG. 1 shows a longitudinal section (along an axis of rotation A) through a shift element 1 according to the invention, which is designed as a lamellar shift element which is also referred to as a multi-disk clutch. The shift element 1 includes a first shift-element half 2 and a second shift-element half 3. In this case, both shift-element halves 2 and 3, which are arranged concentrically to the axis of rotation A, are rotatable about this axis of rotation A, and therefore the shift element 1 is designed as a clutch. Likewise, it is possible that one of the two shift-element halves 2 or 3 is coupled to a transmission housing (not shown) in a rotationally fixed manner, and therefore the shift element 1 would be designed as a brake.

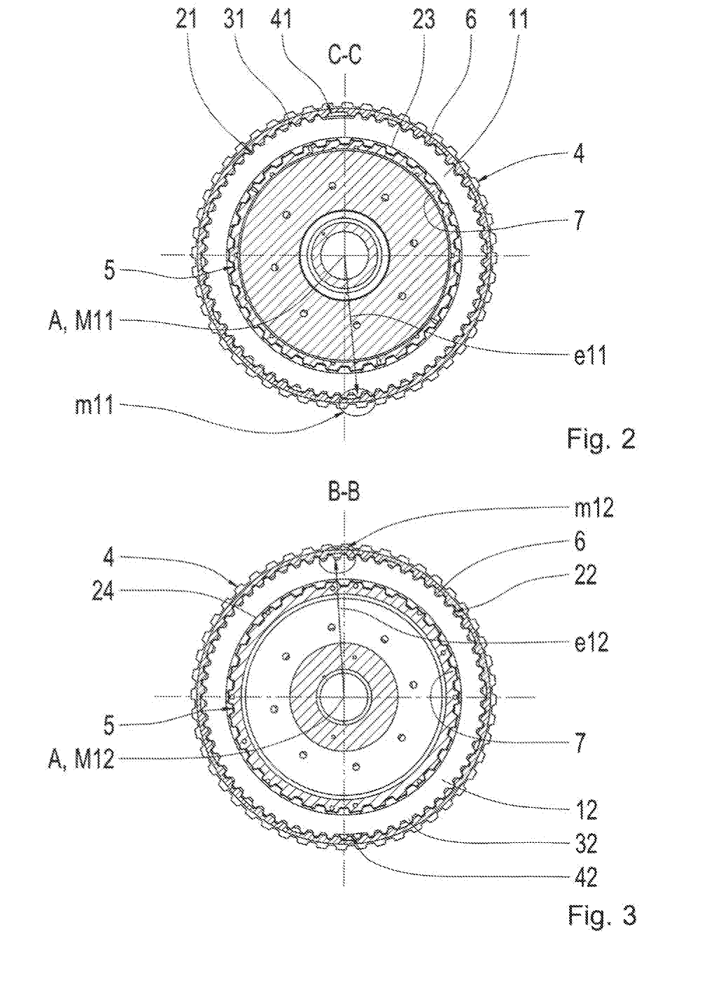

The first shift-element half 2 includes an essentially hollow-cylindrical outer disk carrier 4 including four circular annular disk-shaped outer clutch disks 11, 12, 13 and 14 concentrically arranged radially within the outer disk carrier. The outer disk carrier 4 includes an internally geared outer-disk-carrier tooth system 6. The outer clutch disks 11 to 14 each include external gearing which is represented more clearly in FIGS. 2 and 3 for the outer clutch disks 11 and 12. The external gearings of the outer clutch disks 11 to 14 engage, in the assembled state of the shift-element half 2 or of the shift element 1, into the outer-disk-carrier tooth system 6, and therefore the external gearings are coupled to the outer disk carrier 4 in a rotationally fixed manner. The outer clutch disks 11 to 14 are displaceable axially, i.e., along the axis of rotation A of the shift element 1, within the outer-disk-carrier tooth system 6.

The second shift-element half 3 includes an essentially hollow-cylindrical inner disk carrier 5 including five circular annular disk-shaped inner clutch disks 51, 52, 53, 54 and 55 arranged radially outward and concentrically around the inner disk carrier. The inner disk carrier 5 includes an externally geared inner-disk-carrier tooth system 7. The inner clutch disks 51 to 55 each include an internal gearing which is not visible in the representation. The internal gearings of the inner clutch disks 51 to 55 engage, in the assembled state of the shift-element half 3 or of the shift element 1, into the inner-disk-carrier tooth system 7, and therefore the internal gearings are coupled to the inner disk carrier 5 in a rotationally fixed manner. The inner clutch disks 51 to 55 are displaceable axially, i.e., along the axis of rotation A of the shift element 1, within the inner-disk-carrier tooth system 6.

The inner disk carrier 5 has a smaller diameter than the outer disk carrier 4 and is arranged radially within the outer disk carrier, and therefore the outer clutch disks 11 to 14 and the inner clutch disks 51 to 55 are arranged radially between the outer disk carrier 4 and the inner disk carrier 5. The outer disk carrier 4 and the inner disk carrier 5 are arranged concentrically to one another about the shared axis of rotation A. In addition to their essentially hollow-cylindrical configuration, they can also have a certain taper due to manufacturing.

During operation, the inner clutch disks rotate with the inner disk carrier and the outer clutch disks rotate with the outer disk carrier, provided the shift element is not designed as a brake and one of the two disk carriers is connected to a transmission housing in a rotationally fixed manner. The inner clutch disks can have a circular contour radially outward and the outer clutch disks can have a circular contour radially inward, in both cases corresponding to their circular annular disk shape.

In the assembled state of the shift element 1, the outer clutch disks 11 to 14 and the inner clutch disks 51 to 55 are arranged in alternation in the axial direction. In order to engage the friction-locking shift element 1 for torque transmission, the disks are pressed against one another in the axial direction until the friction force between the disks is so great that a torque can be transmitted. The full torque can be transmitted when the contact pressure is so great that the outer disk carrier 4 and the inner disk carrier 5 or the first shift-element half 2 and the second shift-element half 3 are connected to each other in a friction-locking, rotationally fixed manner.

Due to manufacturing tolerances and in order to ensure the axial mobility of the disks within their tooth systems, a certain radial play exists between the disks and their particular disk carrier. As described at the outset, this results in an indeterminate radial displacement of the outer and/or inner clutch disks with respect to the axis of rotation A. A center of gravity of the particular disk, which corresponds to a disk center M11 or M12 shown in FIGS. 2 and 3 in the case of a shift element from the prior art, is then radially spaced from the axis of rotation A. As a result, during operation and with a rotating disk carrier, a centrifugal force acts on the disk, whereby an imbalance U is generated, which is computed as U=m*e. In this case, m would be the mass of the disk and e would be the distance of the disk center from the axis of rotation A, which cannot be greater than the radial play of the disk 11 or 12 with respect to the axis of rotation A. This yields a centrifugal force F_u which is computed as F_u=U*ω², wherein co is the angular speed which behaves proportionally to the speed of the disk carrier. The disadvantageous effects of the imbalance due to the radially displaced disks were described at the outset.

FIG. 2 shows, in a section C-C from FIG. 1, an axial view of the outer clutch disk 11 which, in the position shown, has been installed into the shift element 1 and is arranged in the outer disk carrier 4. The outer clutch disk 11 includes an external gearing 21 and, radially inward, a circular inside contour 23 around a center M11. The external gearing 21 includes a multitude of outer-clutch-disk teeth 31, wherein, at one point, two adjacent teeth are lacking, and therefore a tooth-system gap 41 is formed here. In contrast to a tooth space which, in a tooth system, exists between two adjacent teeth, a tooth-system gap is understood to mean, in this context, a gap in the tooth system resulting from the lack of one or more teeth.

Due to the tooth-system gap 41, the mass of the outer clutch disk 11 is no longer uniformly distributed around the center M11, and therefore the center of gravity of the outer clutch disk 11 is radially spaced from the center M11, and so the outer clutch disk 11 has an imbalance. In the exemplary embodiment shown, an unbalanced mass m11 corresponds to the mass of the two lacking teeth. The unbalanced mass m11 is formed diametrically opposite the tooth-system gap 41 at a radial distance e11 from the center M11. An imbalance U11 of the outer clutch disk 11 is therefore computed as U11=m11*e11. If the outer clutch disk 11 then rotates with the outer disk carrier 4 during operation, a centrifugal force F_u11 arises due to the imbalance U11, which displaces the outer clutch disk 11 within its radial play in the direction of the arrow marked with the distance e11, where it remains during the rotation. The defined imbalance U11 must be greater than the sum of a manufacturing tolerance-related imbalance and an imbalance resulting from the displacement within the radial play. The displacement direction is therefore ensured. This deliberate displacement due to the defined imbalance U11 generated during the manufacture of the outer clutch disk 11 would not, on its own, solve the problem of the imbalance of the entire shift-element half 2 during operation, however. The overall imbalance for the outer disk carrier 4 would be even greater than it would be with a balanced outer clutch disk according to the prior art, since the overall imbalance would then be computed as the sum of the defined imbalance U11 plus an imbalance resulting from the displacement of the disk with respect to the axis of rotation and the manufacturing tolerance-related imbalance.

In order to explain the effect of the invention, however, reference must also be made to FIG. 3. In FIG. 3, the section B-B from FIG. 1 is represented and shows an axial view of the outer clutch disk 12 which, in the position shown, has been installed into the shift element 1 and is arranged in the outer disk carrier 4. The outer clutch disk 12 includes an external gearing 22 including outer-clutch-disk teeth 32, a circular inside contour 24 around a center M12, and a tooth-system gap 42. Due to the lack of two teeth, an unbalanced mass m12 is formed 180° opposite the tooth-system gap 42 at a distance e12 from the center M12. The dimensions of the outer clutch disks 12 and 11 are equal, as are the sizes of the unbalanced masses m11 and m12 as well as their distances e11 and e12 from the centers M11 and M12, respectively.

The effect of the invention is then that the outer clutch disk 12 which, as shown in FIG. 3, is designed the same as the outer clutch disk 11, is arranged on the outer disk carrier 4 with its tooth-system gap 42 rotated 180° relative to the tooth-system gap 41 of the outer clutch disk 11. The outer clutch disk 12 has an imbalance U12, due to its equal unbalanced mass m12=m11 and the identical radial distance e12=e11, which imbalance is of the same size as the imbalance U11 of the outer clutch disk 11. However, the unbalanced masses m11 and m12 are diametrically opposed, i.e., rotated 180° relative to each other, whereby the disks 11 and 12 also shift in opposite directions within their radial play during operation. The imbalances that are then present, which result from the defined imbalance U11 or U12, respectively, and an imbalance resulting from the displacement of the disk or its center M11 or M12, respectively, with respect to the axis of rotation A, are equal and are opposite in direction. As a result, the resultant centrifugal forces are also opposite in direction and therefore cancel each other out in terms of their effect on the outer disk carrier 4 and, therefore, also on the shift-element half 2. In order to achieve a complete balancing of the shift-element half, all disks should have a defined imbalance and should be arranged appropriately, so that the imbalances of all disks of this shift element compensate each other. This is achieved in the exemplary embodiment shown by way of the outer clutch disks 13 and 14 also being designed and arranged similarly to the outer clutch disks 11 and 12. Therefore, the outer clutch disks 13 and 14 are also rotated, with reference to their tooth-system gaps 43 and 44, 180° relative to each other, which is clear from the representation in FIG. 1 on the basis of the arrangement of the tooth-system gaps 43 and 44.

It is theoretically possible to design only one portion of the disks of a disk carrier with a defined imbalance in a manner according to the invention, although it is therefore also only partially possible to balance the relevant shift-element half.

When two shift-element halves are rotating during operation, it is advantageous when the imbalances of the disks compensate each other on each shift-element half. In the case of a multi-disk clutch, one shift-element half usually includes an even number of disks, and the other shift-element half includes an uneven number of disks, as is also the case in the exemplary embodiment represented in FIG. 1, where the five inner clutch disks 51 to 55 are arranged on the inner disk carrier 5.

In order to completely balance the shift-element half 3 or the inner disk carrier 5, the following embodiments would be possible:

All inner clutch disks 51 to 55 include a tooth-system gap of the same size and having the same distance to the center of the particular inner clutch disk. In this way, it would be possible, for example, to arrange all five inner clutch disks on the inner disk carrier 5 with reference to their tooth-system gaps so as to be rotated relative to each other through the same angle α. The angle α is computed as the quotient of 360° divided by the number of inner clutch disks, i.e., α=360°/5=72° in the present exemplary embodiment. In order to ensure such an arrangement, the division of the tooth-system of the relevant disk or the division of the inner-disk-carrier tooth system 7 must theoretically be a whole-number multiple of the number 5, or generally the number of disks.

One alternative arrangement would be possible, in which the disks are divided into individual groups and then compensate each other within the groups, such as arranging the inner clutch disks 51, 52 and 53 on the inner disk carrier 7 so as to be off-set, with reference to their tooth-system gaps, by 120° and arranging the inner clutch disks 54 and 55 so as to be off-set by 180°. This would yield a greater amount of freedom with respect to the configuration of the numbers of teeth on the disk carrier and/or the disks.

Starting at a number of more than three disks, a different configuration of the individual disks with different unbalanced masses would be theoretically possible, wherein no uniform angle, but rather different angles would be formed between the disks or the unbalanced masses. In this way, for example, two disks could each include one-half the unbalanced mass of the third disk. The first and second disks would then not be rotated relative to each other, and the third disk would be rotated 180° relative to the other two.

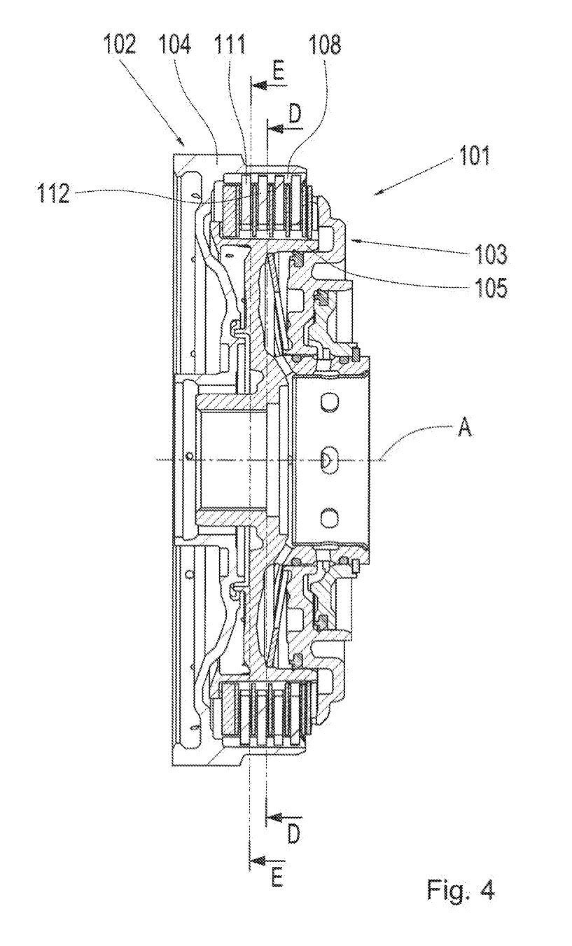

FIG. 4 shows a longitudinal section through a shift element 101 in the assembled state, which is an alternative embodiment of the shift element 1 shown in FIGS. 1 to 3. The shift element 101 includes a first shift-element half 102 and a second shift-element half 103. The first shift-element half 102 includes an outer disk carrier 104 and four outer disks, wherein only the outer clutch disks 111 and 112 will be discussed in the following, in order to simplify the explanation of the invention. The outer disk carrier 104 includes an outer-disk-carrier tooth system 106 including outer-disk-carrier teeth 109. The second shift-element half 103 includes an inner disk carrier 105 including inner clutch disks arranged thereon, which inner clutch disks do not need to be discussed in order to illustrate the invention, however. At least the outer disk carrier 102 is rotatable, with the outer clutch disks, about an axis of rotation A during operation.

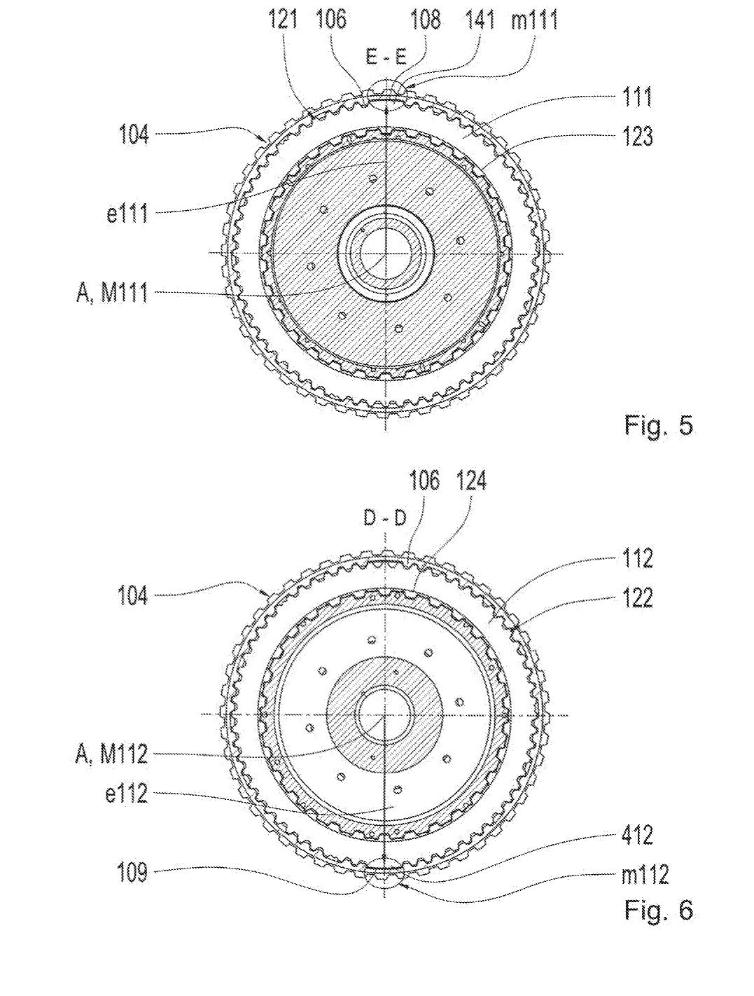

FIG. 5 shows, in a section E-E through the shift element 101 from FIG. 4, an axial view of the outer clutch disk 111. This outer clutch disk is configured essentially in the shape of a circular ring and includes an external gearing 121, as an external contour, as well as a circular inside contour 123. Likewise visible in this sectioning is the outer disk carrier 104 which includes an outer-disk-carrier tooth system 106. A center M111 of the outer clutch disk 111 is concentric to the outer disk carrier 104, whereby the center M111 and the axis of rotation A are concentric or congruent.

The outer clutch disk 111 is arranged within the outer disk carrier 104 concentrically thereto and is coupled thereto in a rotationally fixed manner by the external gearing 121 which engages into the outer-disk-carrier tooth system 106. The outer clutch disk 111—as are all outer clutch disks—is displaceable in the axial direction with respect to the outer disk carrier 104. At one point on the perimeter of the outer clutch disk 111, the outer clutch disk includes a non-toothed area which is formed as a positioning lug 141. The positioning lug can be formed, as in the exemplary embodiment shown, by way of two tooth spaces in the external gearing 121 not having been blanked or milled out, and therefore the positioning lug 141 is a mass accumulation. In the present exemplary embodiment, an unbalanced mass m111 is formed in the positioning lug 141, which corresponds to the mass of the material which fills two tooth spaces of the external gearing 121. This is the simplest way to manufacture a positioning lug. The positioning lug can also be formed, however, by an only partial formation of a tooth system or by an additional radial extension beyond the addendum circle of the external gearing 121. The unbalanced mass m111 formed in the manner described is formed remote from the center M111 or the axis of rotation A by a radial distance e111, whereby the outer clutch disk 111 has, in addition to its imbalance due to manufacturing, an imbalance U111 which is computed as the product of the distance e111 and the unbalanced mass m111 (U111=e111*m111).

FIG. 6 shows, in a section D-D from FIG. 4, an axial view of the outer clutch disk 112. The outer clutch disks 111 and 112 are congruent with respect to their shape and geometric dimensions, such as the eccentricity. Likewise, the thickness or material thickness and the material of at least the outer clutch disks 111 and 112 are equal, which is not shown. Therefore, an external gearing 122 of the outer clutch disk 112 is configured the same as the external gearing 121 and includes a congruent positioning lug 142 which is formed remote from a center M111 of the outer clutch disk 112 or from the axis of rotation A by a radial distance e112 and, therefore, forms an imbalance U112=e112*m112. The center M112 is concentric to the center M111 of the outer clutch disk 111 and the axis of rotation A of the shift element 101. The unbalanced mass m112 is of the same quantity as the unbalance mass m111 of the outer clutch disk 111.

FIGS. 5 and 6 show, on the basis of the two sections D-D and E-E, that the two outer clutch disks 111 and 112 are arranged on the outer disk carrier 104 in such a way that the positioning lugs 141 and 142—and, therefore, the unbalanced masses m111 and m112—are diametrically opposed, i.e., are rotated 180° relative to each other. As a result, the centrifugal forces resulting from the imbalances compensate each other during operation, whereby the shift-element half 102 is balanced when all outer clutch disks on the outer disk carrier 104 are designed and arranged in such a way.

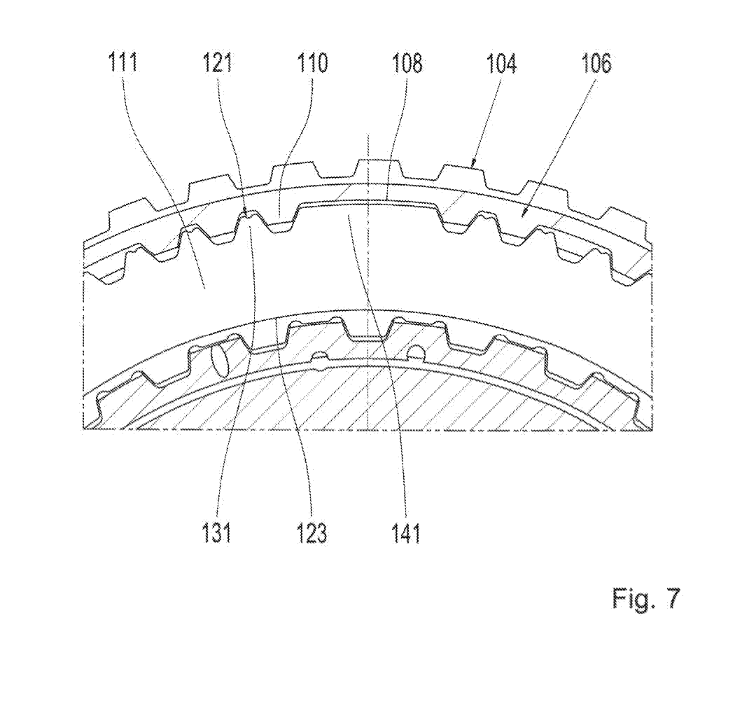

FIG. 7 shows a detailed section from FIG. 5. In order to ensure that the outer clutch disks 111 and 112 designed in this way can be arranged on the outer disk carrier 104, the outer disk carrier includes, for the purpose of accommodating the positioning lugs 141 and 142, two groove-shaped outer-disk-carrier tooth-system gaps 108 and 109 which are therefore diametrically opposed, as shown in FIGS. 5 and 6. In FIG. 7, for the sake of clarity, only the outer-disk-carrier tooth-system gap 108 is visible, into which the positioning lug 141 engages in the assembled state of the shift-element half 102. Since, in the exemplary embodiment shown (FIGS. 4 to 7), the positioning lug 141 is developed via the non-formation of two tooth spaces, the outer-disk-carrier tooth-system gap 108 (and, similarly, the outer-disk-carrier tooth-system gap 109 which is not shown in FIG. 7) is formed by the removal or non-formation of two outer-disk-carrier teeth 110 on the outer disk carrier 104.

The advantage of this embodiment is a high certainty of assembly, since an outer clutch disk 111 or 112 can be mounted only in two possible positions which are very easily differentiated. It is therefore ensured that the outer clutch disks are located precisely in the positions, in which the defined imbalances cancel each other out and, therefore, the particular shift-element half is balanced, i.e., has no imbalance with a corresponding disadvantageous effect of a resultant centrifugal force.

Modifications and variations can be made to the embodiments illustrated or described herein without departing from the scope and spirit of the invention as set forth in the appended claims.

### REFERENCE CHARACTERS

1 clutch, shift element
2 shift-element half
3 shift-element half
4 outer disk carrier
5 inner disk carrier
6 outer-disk-carrier tooth system
7 inner-disk-carrier tooth system
11 outer clutch disk
12 outer clutch disk
13 outer clutch disk
14 outer clutch disk
21 external gearing
22 external gearing
23 inside contour of the outer clutch disk 11
24 inside contour of the outer clutch disk 12
31 outer-clutch-disk tooth
32 outer-clutch-disk tooth
41 tooth-system gap
42 tooth-system gap
43 tooth-system gap
44 tooth-system gap
51 inner clutch disk
52 inner clutch disk
53 inner clutch disk
54 inner clutch disk
55 inner clutch disk
101 clutch, shift element
102 shift-element half
103 shift-element half
104 outer disk carrier
105 inner disk carrier
106 outer-disk-carrier tooth system
108 outer-disk-carrier tooth-system gap
109 outer-disk-carrier tooth-system gap
110 outer-disk-carrier tooth
111 outer clutch disk
112 outer clutch disk
121 external gearing
122 external gearing
123 inside contour of the outer clutch disk 11
124 inside contour of the outer clutch disk 12
131 outer-clutch-disk tooth
141 positioning lug
142 positioning lug
A axis of rotation
e distance of the unbalanced mass from the axis of rotation
e11 distance of the unbalanced mass m11 from the axis of rotation A
e12 distance of the unbalanced mass m12 from the axis of rotation A
e111 distance of the unbalanced mass m111 from the axis of rotation A
e112 distance of the unbalanced mass m112 from the axis of rotation A
m unbalanced mass
m11 unbalanced mass of the outer clutch disk 11
m12 unbalanced mass of the outer clutch disk 12
m111 unbalanced mass of the outer clutch disk 111
m112 unbalanced mass of the outer clutch disk 112
M11 disk center of the outer clutch disk 11
M12 disk center of the outer clutch disk 12
M111 disk center of the outer clutch disk 111
M112 disk center of the outer clutch disk 112
U imbalance
U11 imbalance of the outer clutch disk 11
U12 imbalance of the outer clutch disk 12

1-14. (canceled)

15. A shift element (1) for an automatic transmission of a motor vehicle, comprising a first (2) and a second shift-element half (3), each of the first and second shift-element halves (1,2) having a disk carrier (4, 5) and a plurality of essentially annular disks (11-14, 51-54), wherein each disk carrier and the respective plurality of disks are coupled in a form-locking and rotationally fixed manner and such that the respective plurality disks is axially movable relative to the corresponding disk carrier, and wherein the first and second shift-element halves (2, 3) are couplable through the plurality of disks in a rotationally fixed manner or so as to slip, the shift element (1) characterized in that:
at least two disks (11, 12) of the plurality of disks (11-14) of the first shift-element half (2) are configured such that the at least two disks (11, 12) each have a defined imbalance (U11, U12);
each of the at least two disks (11, 12) is arranged or is rotated relative to the other disks of the at least two disks (11, 12) on the disk carrier (4) of the first shift-element half (2), with respect to a location and size of a respective defined unbalanced mass (m11, m12), in such a way that each of the at least two disks (11, 12) shifts radially during operation deliberately in a direction of the respective unbalanced mass (m11, m12) or of a center of gravity resulting therefrom such that, in sum, imbalances occurring during operation due to the displacement of the at least two disks (11, 12) cancel out or are at least partially compensated.

16. The shift element of claim 15, wherein the size of the each defined imbalance (U11, U12) is selected such that each defined imbalance is greater than a manufacturing tolerance-related imbalance of the respective disk plus an imbalance resulting from radial displacement of a center of gravity of the respective disk from an axis of rotation (A) of the respective disk.

17. The shift element of claim 15, wherein, when there is an even number of disks in the at least two disks (11, 12), each group of two disks (11, 12) in the at least two disks (11, 12) has the same defined imbalance and is arranged on the disk carrier (4) of the first shift-element half (2) such that the unbalanced masses (m11, m12) and the centers of gravity of the two disks in each group of two disks (11, 12) are rotated 180° relative to each other about an axis of rotation (A) of the disk carrier (4) or the first shift-element half (2).

18. The shift element of claim 17, wherein each disk carrier and each disk of the first and second shift-element halves (1,2) comprises a driving profile, by which each plurality of disks (11-14, 51-54) is coupled to a respective disk carrier (4, 5) in a form-locking and rotationally fixed manner, and wherein each of the at least two disks (11, 12) includes at least one off-center recess which is configured such the center of gravity is radially spaced from an axis of rotation in each of the at least two disks (11, 12) and such that each of the at least two disks (11, 12) has the respective defined unbalanced mass (m11, m12).

19. The shift element of claim 18, wherein:
the disk carrier of the first shift-element half (2) is an outer disk carrier (4) and the plurality of disks of the first shift-element half (2) are a plurality of outer clutch disks (11, 12);
the disk carrier of the second shift-element half (3) is an inner disk carrier (5) and the plurality of disks of the second shift-element half (3) is a plurality of inner clutch disks (51-54);
the outer disk carrier (4) includes an internally geared outer-disk-carrier tooth system (6) and the outer clutch disks (11, 12) each include external gearing (21, 22), by which the outer clutch disks (11, 12) are coupled to the outer disk carrier (4) in a rotationally fixed manner;
the inner disk carrier (5) includes an externally geared inner-disk-carrier tooth system (7) and the inner clutch disks (51-54) each include internal gearing, by which the inner clutch disks (51-54) are coupled to the inner disk carrier (5) in a rotationally fixed manner;
at least one recess in the form of a tooth-system gap (41, 42) is formed in the external gearing (21, 22) of at least two outer clutch disks (11, 12), in the internal gearing of at least two inner clutch disks, or in both the external gearing (21, 22) of the at least two outer clutch disks (11, 12) and the internal gearing of the at least two inner clutch disks; and
the tooth-system gap (41, 42) formed by at least one omitted tooth (31, 32), the at least one omitted tooth (31, 32) forming the respective defined imbalance in each of the at least two disks (11, 12).

20. The shift element of claim 19, wherein an even number of outer clutch disks (11, 12) have the defined imbalance, the tooth-system gap (41, 42) is formed on each of even number of outer clutch disks (11, 12) via at least two adjacently situated omitted teeth, and each of even number of outer clutch disks (11, 12) has an identical defined imbalance that corresponds to the mass of the at least two adjacently situated omitted teeth.

21. The shift element of claim 17, wherein each disk carrier and each disk of the first and second shift-element halves (1,2) comprises a driving profile, by which each plurality of disks (11-14, 51-54) is coupled to a respective disk carrier (4, 5) in a form-locking and rotationally fixed manner, wherein each of the at least two disks (11, 12) includes at least one radially oriented bulge which is configured such the center of gravity is radially spaced from an axis of rotation in each of the at least two disks (11, 12) and such that each of the at least two disks (11, 12) has the respective defined unbalanced mass (m11, m12), and wherein the driving profile of the disk carrier assigned to the at least two disks (11, 12) includes a driving-profile gap which receives the at least one bulge.

22. The shift element as claimed in claim 21, wherein:
the disk carrier of the first shift-element half (102) is an outer disk carrier (104) and the plurality of disks of the first shift-element half (102) are a plurality of outer clutch disks (111, 112);
the disk carrier of the second shift-element half (103) is an inner disk carrier (105) and the plurality of disks of the second shift-element half (103) is a plurality of inner clutch disks;
the outer disk carrier (104) includes an internally geared outer-disk-carrier tooth system (106) and the outer clutch disks (111, 112) each include external gearing (121, 122), by which the outer clutch disks (111, 112) are coupled to the outer disk carrier (104) in a rotationally fixed manner;
the inner disk carrier (105) includes an externally geared inner-disk-carrier tooth system (107) and the inner clutch disks each include internal gearing, by which the inner clutch disks are coupled to the inner disk carrier (105) in a rotationally fixed manner;
one or more at least partially non-toothed area which forms a positioning lug (141, 142) is formed in the external gearing (121, 122) of at least two outer clutch disks (111, 112), in the internal gearing of at least two inner clutch disks, or in both the external gearing (121, 122) of the at least two outer clutch disks (111, 112) and in the internal gearing of the at least two inner clutch disks such that each of the at least two outer clutch disks (111, 112) comprises at least one radially outward-oriented positioning lug (141) and/or each of the at least two inner clutch disks comprises a radially inward-oriented positioning lug due to which the respective defined imbalance results; and
on the disk carrier assigned to the at least two disks (11, 12), a disk carrier tooth-system gap (108) is formed by the at least partial lack of at least one disk carrier tooth (109), the positioning lug (141, 412) received within the disk carrier tooth-system gap (108).

23. The shift element as claimed in claim 22, wherein the one or more at least partially non-toothed area which forms the positioning lug (141, 142) is formed by way of no tooth spaces having been blanked or milled out at the location of the positioning lug.

24. The shift element of claim 15, wherein, when there is an odd number of disks in the at least two disks (11, 12), each of the at least two disks (11, 12) has the same defined imbalance and is arranged on the disk carrier (4) of the first shift-element half (2) such that the unbalanced masses (m11, m12) and the centers of gravity of the at least two disks (11, 12) are rotated relative to each other by a certain identical angle about a central axis of the disk carrier (4), the certain identical angle computed as a quotient of 360° divided by the number of disks in the at least two disks (11, 12).

25. The shift element of claim 24, wherein each disk carrier and each disk of the first and second shift-element halves (1,2) comprises a driving profile, by which each plurality of disks (11-14, 51-54) is coupled to a respective disk carrier (4, 5) in a form-locking and rotationally fixed manner, and wherein each of the at least two disks (11, 12) includes at least one off-center recess which is configured such the center of gravity is radially spaced from an axis of rotation in each of the at least two disks (11, 12) and such that each of the at least two disks (11, 12) has the respective defined unbalanced mass (m11, m12).

26. The shift element of claim 25, wherein:
the disk carrier of the first shift-element half (2) is an outer disk carrier (4) and the plurality of disks of the first shift-element half (2) are a plurality of outer clutch disks (11, 12);
the disk carrier of the second shift-element half (3) is an inner disk carrier (5) and the plurality of disks of the second shift-element half (3) is a plurality of inner clutch disks (51-54);
the outer disk carrier (4) includes an internally geared outer-disk-carrier tooth system (6) and the outer clutch disks (11, 12) each include external gearing (21, 22), by which the outer clutch disks (11, 12) are coupled to the outer disk carrier (4) in a rotationally fixed manner;
the inner disk carrier (5) includes an externally geared inner-disk-carrier tooth system (7) and the inner clutch disks (51-54) each include internal gearing, by which the inner clutch disks (51-54) are coupled to the inner disk carrier (5) in a rotationally fixed manner;
at least one recess in the form of a tooth-system gap (41, 42) is formed in the external gearing (21, 22) of at least two outer clutch disks (11, 12), in the internal gearing of at least two inner clutch disks, or in both the external gearing (21, 22) of the at least two outer clutch disks (11, 12) and the internal gearing of the at least two inner clutch disks; and
the tooth-system gap (41, 42) formed by at least one omitted tooth (31, 32), the at least one omitted tooth (31, 32) forming the respective defined imbalance in each of the at least two disks (11, 12).

27. The shift element of claim 26, wherein an even number of outer clutch disks (11, 12) have the defined imbalance, the tooth-system gap (41, 42) is formed on each of even number of outer clutch disks (11, 12) via at least two adjacently situated omitted teeth, and each of even number of outer clutch disks (11, 12) has an identical defined imbalance that corresponds to the mass of the at least two adjacently situated omitted teeth.

28. The shift element of claim 24, wherein each disk carrier and each disk of the first and second shift-element halves (1,2) comprises a driving profile, by which each plurality of disks (11-14, 51-54) is coupled to a respective disk carrier (4, 5) in a form-locking and rotationally fixed manner, wherein each of the at least two disks (11, 12) includes at least one radially oriented bulge which is configured such the center of gravity is radially spaced from an axis of rotation in each of the at least two disks (11, 12) and such that each of the at least two disks (11, 12) has the respective defined unbalanced mass (m11, m12), and wherein the driving profile of the disk carrier assigned to the at least two disks (11, 12) includes a driving-profile gap which receives the at least one bulge.

29. The shift element as claimed in claim 28, wherein:
the disk carrier of the first shift-element half (102) is an outer disk carrier (104) and the plurality of disks of the first shift-element half (102) are a plurality of outer clutch disks (111, 112);
the disk carrier of the second shift-element half (103) is an inner disk carrier (105) and the plurality of disks of the second shift-element half (103) is a plurality of inner clutch disks;
the outer disk carrier (104) includes an internally geared outer-disk-carrier tooth system (106) and the outer clutch disks (111, 112) each include external gearing (121, 122), by which the outer clutch disks (111, 112) are coupled to the outer disk carrier (104) in a rotationally fixed manner;
the inner disk carrier (105) includes an externally geared inner-disk-carrier tooth system (107) and the inner clutch disks each include internal gearing, by which the inner clutch disks are coupled to the inner disk carrier (105) in a rotationally fixed manner;
one or more at least partially non-toothed area which forms a positioning lug (141, 142) is formed in the external gearing (121, 122) of at least two outer clutch disks (111, 112), in the internal gearing of at least two inner clutch disks, or in both the external gearing (121, 122) of the at least two outer clutch disks (111, 112) and in the internal gearing of the at least two inner clutch disks such that each of the at least two outer clutch disks (111, 112) comprises at least one radially outward-oriented positioning lug (141) and/or each of the at least two inner clutch disks comprises a radially inward-oriented positioning lug due to which the respective defined imbalance results; and
on the disk carrier assigned to the at least two disks (11, 12), a disk carrier tooth-system gap (108) is formed by the at least partial lack of at least one disk carrier tooth (109), the positioning lug (141, 412) received within the disk carrier tooth-system gap (108).

30. The shift element as claimed in claim 29, wherein the one or more at least partially non-toothed area which forms the positioning lug (141, 142) is formed by way of no tooth spaces having been blanked or milled out at the location of the positioning lug.

31. The shift element of claim 15, wherein all disks (11, 12, 13, 14) of the plurality of disks (11-14) of the first shift-element half (2) have a defined imbalance.

32. The shift element of claim 15, wherein the shift element (1) is configured as a brake and the first shift-element half (2) is a rotary shift-element half of the first and second shift-element halves (2, 3).

33. The shift element of claim 15, wherein the shift element (1) is configured as a clutch and the first and second shift-element halves (2, 3) are both rotary shift-element halves, at least two disks of the plurality of disks (51-54) of the second shift-element half (3) also configured such that the at least two disks of the plurality of disks (51-54) of the second shift-element half (3) each have a defined imbalance.

34. An automatic transmission for a motor vehicle comprising the shift element of claim 15.
